(19) United States
(12) Patent Application Publication
(10) Pub. No.: US 2003/0089243 A1
(43) Pub. Date: May 15, 2003

(54) System of cooking or heating food products with microwaves and hot oil

(76) Inventor: Jing-Yau Chung, Houston, TX (US)

Correspondence Address: MARK A OATHOUT, 3730 KIRBY DRIVE, SUITE 830, HOUSTON, TX, 77098

(21) Appl. No.: 10/290,870

(22) Filed: Nov. 8, 2002

Related U.S. Application Data
(60) Provisional application No. 60/348,209, filed on Nov. 9, 2001.
(60) Provisional application No. 60/340,917, filed on Dec. 12, 2001.

(51) Int. Cl. A23L 3/28

(52) U.S. Cl. 99/451; 99/483

(57) ABSTRACT

For cooking/heating a food product, a simpler yet more effective carousel system is used in a microwave and/or infrared, and hot oil and/or hot gas oven; a continuous oven surface cleaning system is included; and an improved hot oil/gas heating and circulating device is used in conjunction with the improved carousel system.

### CROSS-REFERENCE TO RELATED APPLICATIONS

This application is a utility application based on the U.S. Provisional application No. 60/348,209, Filed Nov. 9, 2001, and No. 60/340,917, Filed Dec. 12, 2001 and claims the benefit of same.

### STATEMENTS REGARDING FEDERALLY SPONSOR RESEARCH OR DEVELOPMENT

Not applicable.

### REFERENCE TO A MICROFICHE APPENDIX

Not applicable.

### BACKGROUND OF THE INVENTION

### Description of the Related Art

The current invention is an improvement over the U.S. patent, “System of Cooking or Heating Food Products with Microwaves and Hot Oil” issued to the current inventor on Jun. 30, 1998 (U.S. Pat. No. 5,771,786). The above mentioned patent will be referred to as “the existing patent” hereafter.

The existing patent involves a method and a device for cooking and heating food products using microwaves and hot oil simultaneously in an oven. As a preferred embodiment, the oven uses a carrousel system for a continuous input of food products to be processed in the oven. The carousel system also provides a continuous output of the processed food products from the oven. All input and output operations can be performed from one operator position with the carousel system.

### BRIEF SUMMARY OF THE INVENTION

The current improvements over the existing patent include, (a) a simpler yet more effective carrousel system is used in the microwave and hot oil oven, (b) a continuous oven surface cleaning system is included and (c) an improved hot oil heating and circulating device is used in conjunction with the improved carrousel system.

It should be noted that, although microwave with different wavelengths is commonly used to generate heat in household cooking or industrial food processing, other waves in the electromagnetic spectrum such as the infrared radiation or visible light, with shorter wavelength than microwave, can also be used to generate heat. Furthermore, other hot convective media such as hot gas can be used as a convective medium. The current invention uses microwave and hot oil oven as the preferred embodiment. In its generality, the current invention includes the use of any other hot convective medium or a combination of hot convective media and any other wave or a combination of waves in the electromagnetic spectrum.

### BRIEF DESCRIPTION OF THE SEVERAL VIEWS OF THE DRAWINGS

For a fuller understanding of the invention, the following drawings are provided in conjunction with the detail descriptions of the invention, which will be presented in the next section:

FIG. 1A is an illustration of the sectional side view of the preferred embodiment of the present invention with microwave and hot oil as the heating means.

FIG. 1B is an illustration of the top view of the present invention shown in FIG. 1A.

FIG. 1C is an illustration of the sectional side view of the preferred embodiment of the present invention with microwave and hot gas as the heating means.

FIG. 1D is an illustration of the sectional side view of the preferred embodiment of the present invention with microwave and combined hot oil and hot gas as the heating means.

FIG. 2 is an illustration of the partial sectional front view of the exhaust system.

FIG. 3 is an illustration of the oblique view of the outer conductor walls of the oven showing the boundary surface of the microwave field.

FIG. 4 is an illustration of the partial sectional side view of the microwave and hot oil oven.

FIG. 5 is an illustration of the sectional top view of the microwave and hot oil oven.

FIG. 6 is an illustration of one embodiment of the food compartment basket carrying food products around the carrousel.

### DETAILED DESCRIPTION OF THE INVENTION

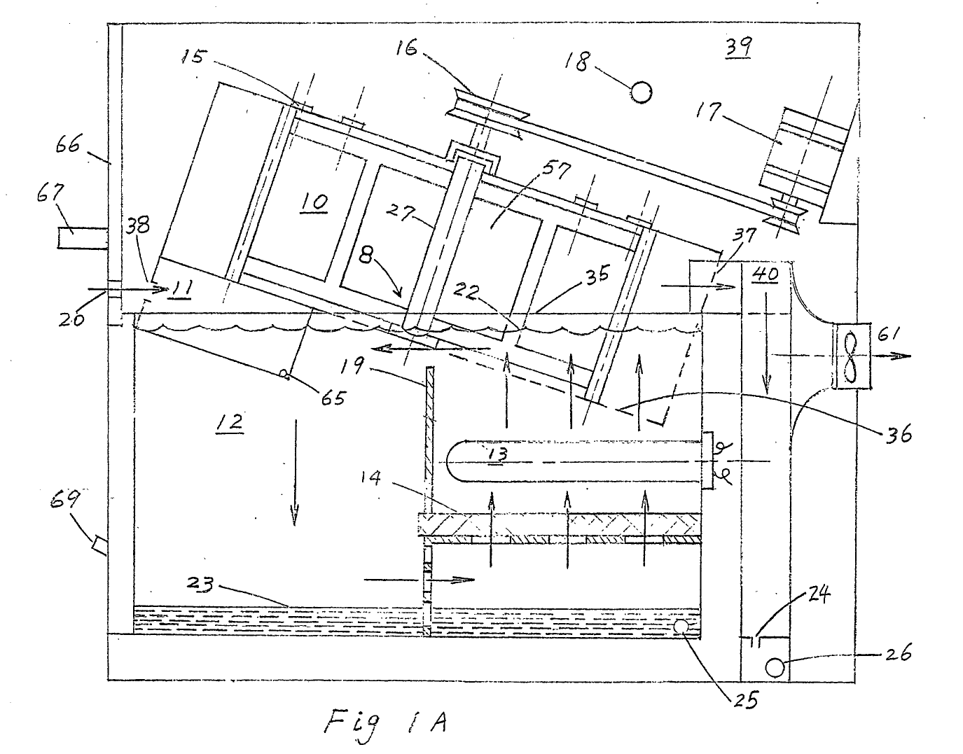

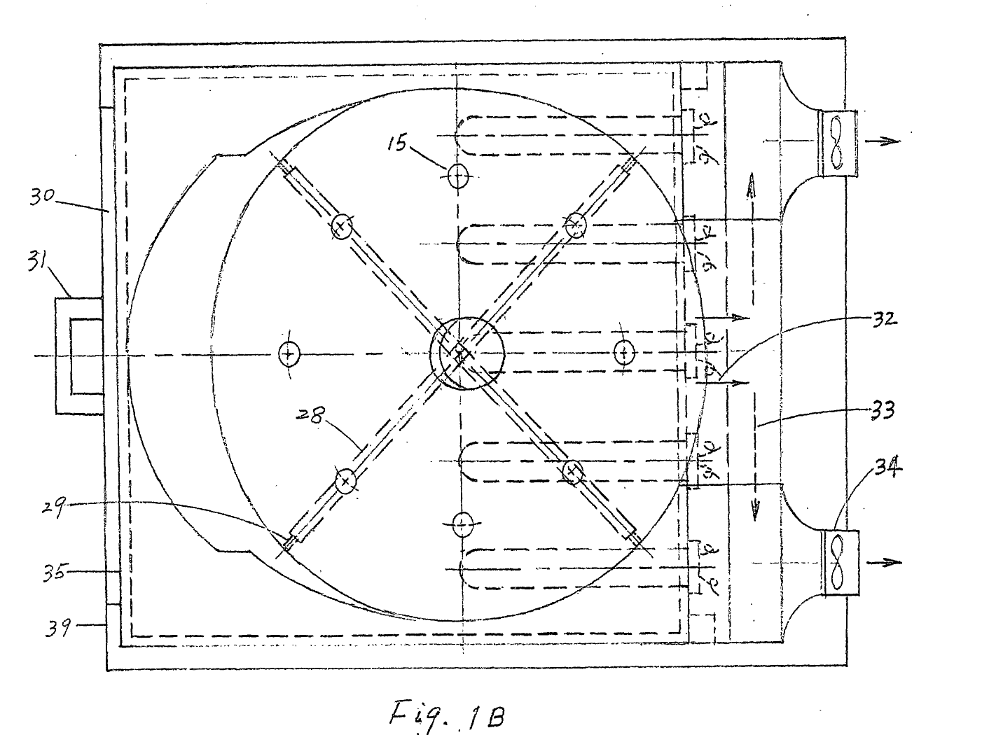

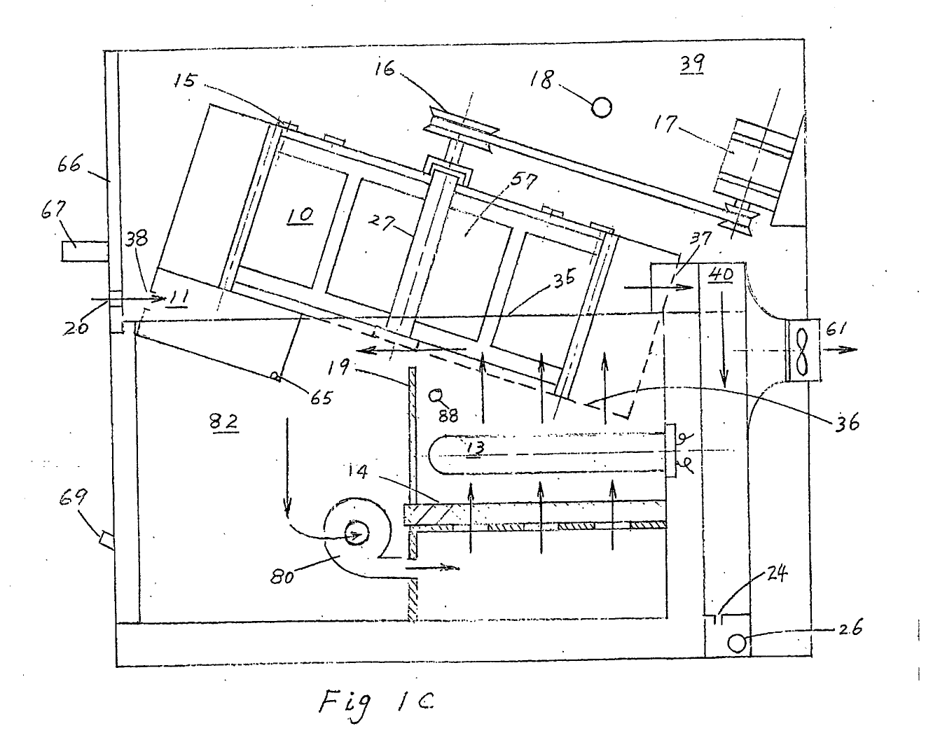

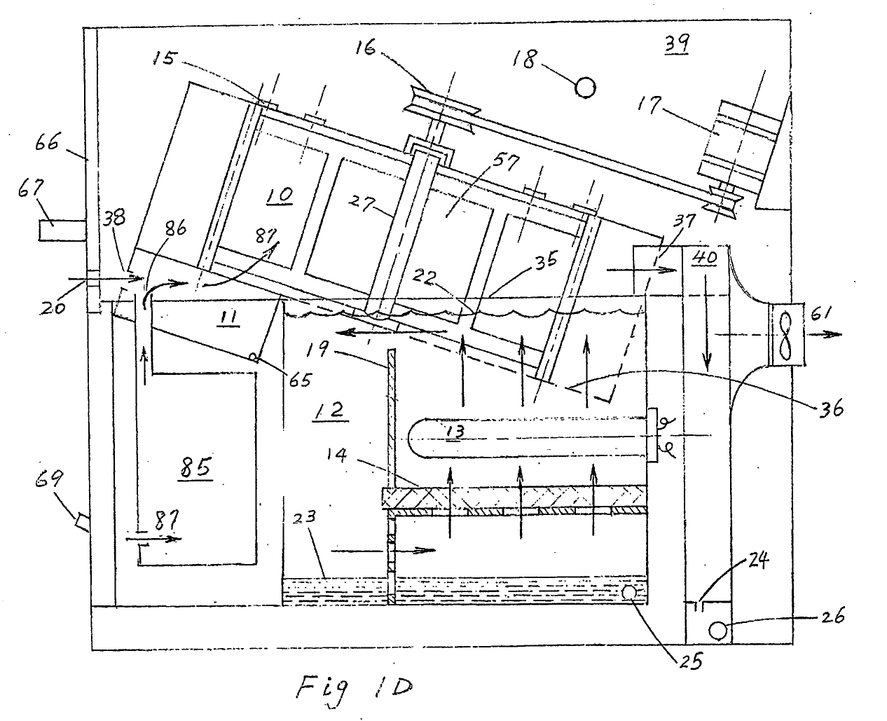

With reference to FIG. 1A, the current invention mainly includes a carousel 8 within an microwave and hot oil oven 10 with a main drive shaft 27 and a carousel drive shaft 57, a food receptacle compartment 11, an oil heater system 12, an exhaust system 40 and an enclosure 39 for the entire system. The top view of this embodiment is shown in FIG. 1B.

As shown in FIGS. 1A and 1B, the oven 10 is tilted with an angle with respect to a horizontal plane such as the oil surface 22. The lower portion of the oven is submerged in the oil within the heater system 12. The hot oil feeds into the oven 10 and returns to the heater system 12 through relatively small holes on the perforated walls 36, which are indicated by a dotted line in FIG. 1A. The oil is heated with one or more heating element 13 in the oil heater system 12. Due to natural heat convection, the heated oil flows upward and enters oven 10 through the perforated wall 36. Using a partition 19, the oil returning from oven 10 is guided towards the other side of the heater system 12, making an oil-circulation loop as depicted by the arrows in FIG. 1A. The moisture generated from the frying food products and being carried out of oven 10 by the returned oil, settles on the bottom 23 of the heater system 12. This water on the bottom of the heater system is drained out of the system periodically by means of a commercially available suction device (not shown). An oil filter set 14 is used to remove the food particles in the oil, before the oil returns back for reheating in the region where the heating element 13 is located. The filter set 14 is removable for cleaning. To further remove the food particles in the oil, a commercially available motor-driven continuous filter system (not shown) can be installed in the system as an optional device. In operation, a thermostat (not shown) placed in the oil within the heater system 12 is used to control the oil temperature.

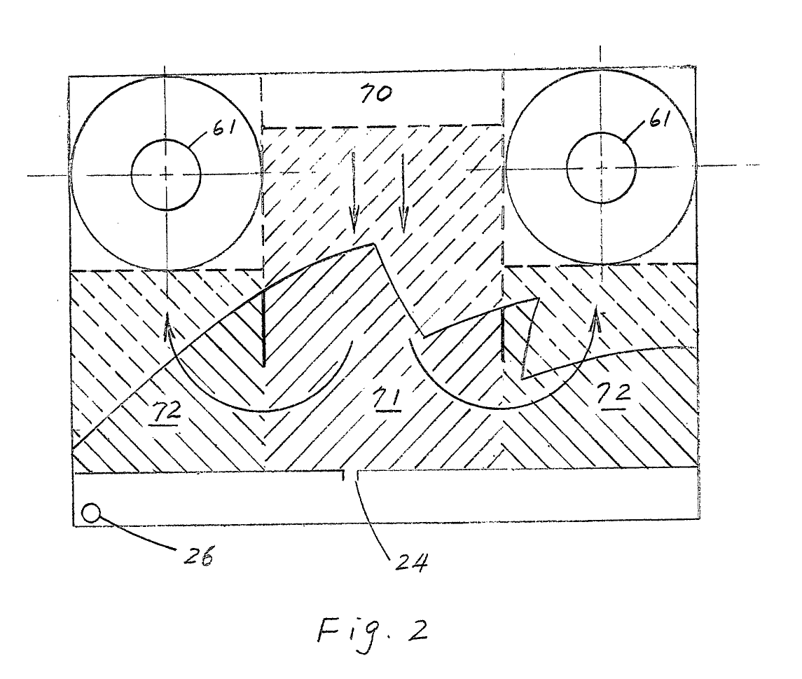

During operations, the exhaust system 40 uses one or more blowers to suck the fresh air into oven 10 through openings 38 on the food receptacle compartment 11 as well as through an opening 20 on the door 66 of enclosure 39. The fresh air drawn into oven 10 mixes with water vapor and oil particles generated in the oven. This mixture along with bubbles on the oil surface, if it is generated, is then drawn out of oven 10 through the perforated wall 37 as shown in FIG. 1A. The oil particles, the moisture and possibly bubbles in the exhaust are removed by a series of filters before the exhaust air reaches the outlet 61. FIG. 2 shows the partial sectional front view of an embodiment of the exhaust system 40. In this embodiment, the exhaust air is sucked into the exhaust system from inlet 70 by two symmetrical blowers (not shown). The exhaust air is then filtered by an initial filter 71 and a subsequent filter 72 before it reaches the two outlets 61. An optional oil drain hole 24, shown in FIGS. 1A and 2, is used to drain the excessive oil and water, which are produced from the initial filtering of the exhaust air by filter 71 and are settled on the bottom of the exhaust duct. With this option, the accumulated oil and water on the bottom of the exhaust system 40 is then sucked out of the system periodically with a commercially available suction device (not shown) through suction hole 26 shown in FIGS. 1A and 2. As shown in FIGS. 1A and 1B, the top part of the oil heater is partially covered by a flat plat 35, which is welded or connected airtight to the outer edge of the oven 10. Both the flat plat 35 and the oven 10 keep any oil particle and water vapor from getting into the upper part of enclosure 39.

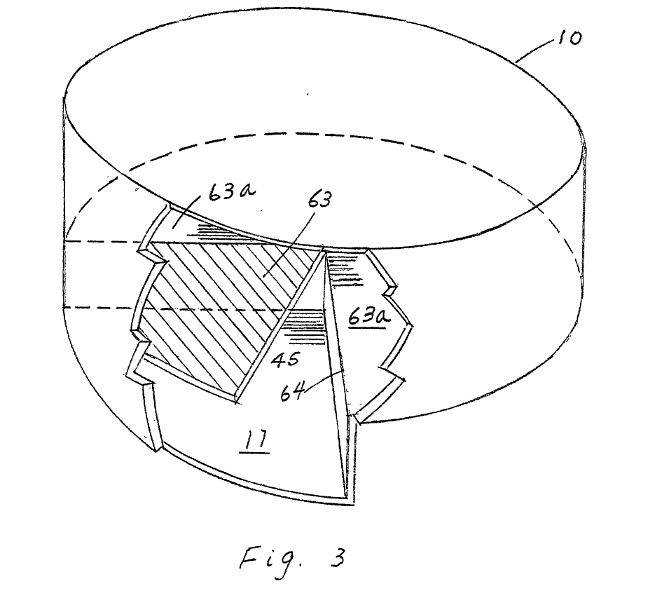

As shown in FIGS. 1A and 1B, a number of magnetrons 15 are installed on the upper wall of the oven 10, which generates a microwave field confined by the conductor walls of oven 10 and the conductor walls of the food receptacle compartment 11. These conductor walls, which define the boundary of the microwave field, are further illustrated in FIG. 3. In order to keep the magnetrons from being stained by the oven grease, the magnetrons can be isolated from the oven cavity by a glass or other non conductor which transmits the microwave energy emitted from the magnetrons.

With reference to FIG. 3, the shaded area 63 above a portion of the food receptacle compartment 11 is made of a dielectric material and is at the same level as the oven floor 63a. This shaded area 63 makes up a portion of the oven floor 63a. An opening at 45 shown in FIG. 3, between the shaded area 63 and the boundary line 64 of the conductor oven floor 63a, is provided for receiving the cooked or heated food products to the food receptacle compartment 11. When the individual food product in oven 10 is moving over the opening 45 by the rotating carousel 8, it is dropped down to the food receptacle compartment 11 through the opening at 45. This transferring of the processed food products into the receptacle compartment 11 will be described in more detail later. The opening at 45 also serves as the air passageway for the air intake from hole 38 (illustrated in FIG. 1A) to the oven 10.

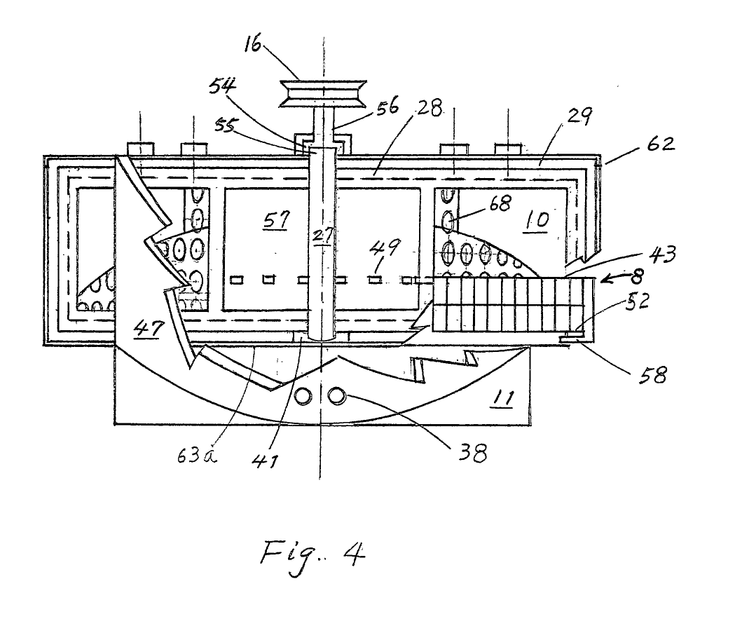

The system enclosure 39 is made of a conductor material. The enclosure 39 has a front door 66 with a door handle 67 as depicted in FIG. 1A. An optional safety switch (not shown) is built on door 66, such that it automatically shut off the microwave power when the door is opened. As will be described in more detail later with an illustration in FIG. 4, the oven 10 has a door with an independent safety shutoff switch. As mentioned previously, when the oven 10 is in use, the microwave field is confined within the conductor walls of oven 10 and the conductor walls of food receptacle compartment 11. Any leakage of the microwave energy out of this confinement will be detected by a microwave leak detector 18, which is installed within the enclosure 39 as shown in FIG. 1A. In a case of microwave leakage, detector 18 triggers an automatic shutoff of the microwave power.

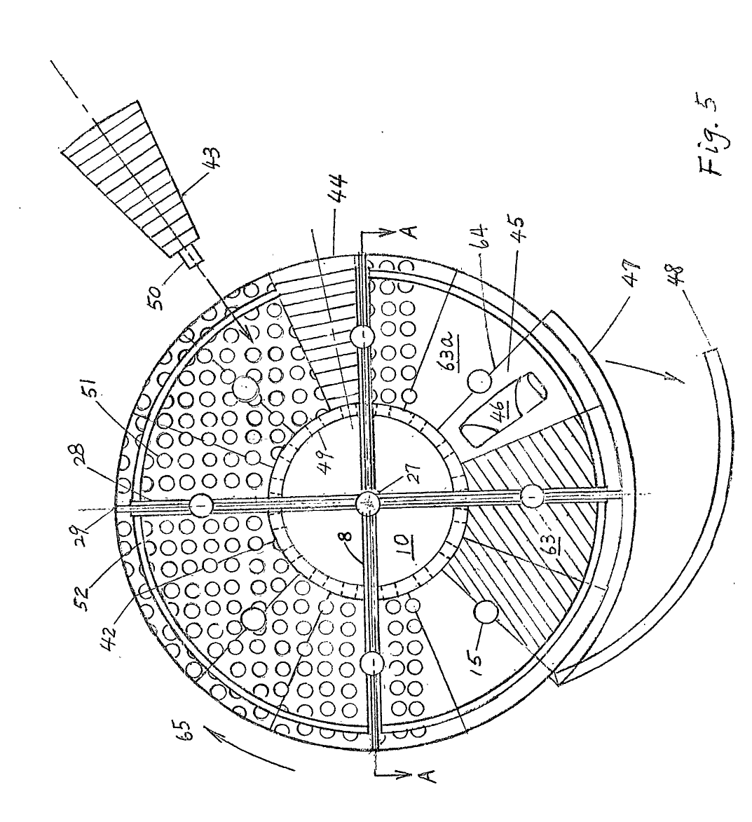

As shown in FIG. 1A, the main drive shaft 27 of the oven is driven by a pulley 16, which is driven by an electric motor 17. The drive mechanism as well as the carousel 8, which convey the food products in the oven 10, will be described in more detail later with illustrations in FIGS. 4 and 5.

As shown in FIG. 4, as an embodiment of the carousel system, a shaft 56, which is made of a conductor material, is connected to the pulley 16 at one end. Its other end 54 is connected to the end 55 of the main drive shaft 27, which is made of a dielectric material. The end 54 and the end 55 are coupled with a square or other non-circular shaped coupling. It should be noted that, in this embodiment, the surface of the end of the shaft 56 at 54 is also a part of the above mentioned boundary surface of the microwave field. The other end of the main drive shaft 27 is rotating on a stationary piece 41 during operation. The stationary piece 41, which is made of either a conductor material or a low friction dielectric material, is rigidly mounted on the floor 63a of the oven 10. To minimize the frictional force between the end of the drive shaft 27 and a stationary surface, an optional ball bearing made of a dielectric material can be used to replace the stationary piece 41.

As depicted in FIGS. 4 and 5, a number of sweeper frames 28, which are made of a dielectric material, are connected rigidly to the main drive shaft 27 in the radial directions. The shape, the dimension and the position of each of the sweeper frames 28 are designed in such a way that the outer edge of the frame is close to but not contacting the inner surface of oven 10. Each of the frames 28 has a groove along its outer edge, which houses a relatively thin and soft dielectric sweeper strip 29 in such a way that part of the strip 29 is secured in the groove and the outer edge of the strip 29 lightly touches the inner surface of the oven 10. In operation, the shaft 27 drives the sweeper frames 28 to a rotational motion and the sweeper strip 29 wipes and cleans the inner surface of the oven 10.

The frames 28 are also rigidly connected to a carousel drive shaft 57 as well as a circular basket holder 52 as shown in FIGS. 4 and 5. As depicted in FIG. 5, to secure the removable food compartment basket 43 (to be described in further detail below) on the carousel system, the tip 50 of the compartment basket 43 is inserted in a hole 49 on the carousel drive shaft 57. As illustrated in FIG. 4, the compartment basket 43 is also secured by the basket holder 52 by means of a hook 58, which attaches the basket 43 to the basket holder 52. The main function of the basket holder 52 and the hook 58 is to hold down the basket 43 on to the oven floor 63a, when the basket is submerged in the oil with a food product in it.

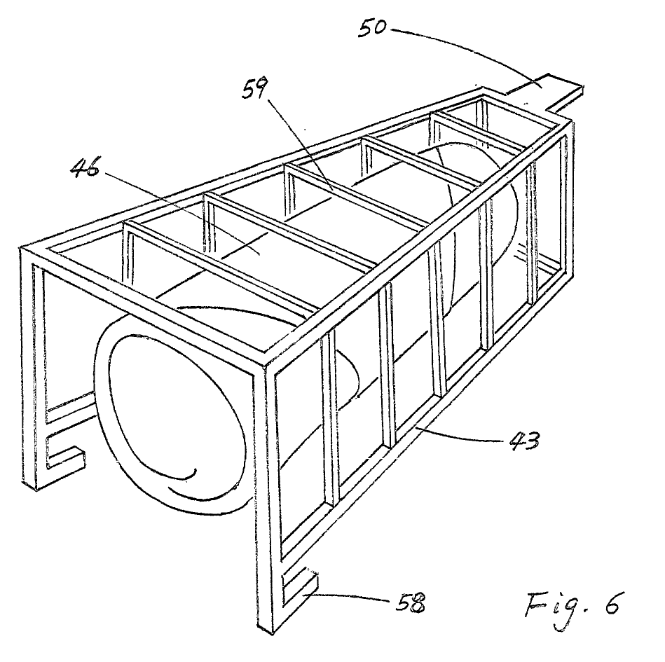

With reference to FIG. 5, a compartment basket 43 in the carousel system in operation is shown at 44. The lines 42 indicate the borderlines between the compartment baskets 43 in the carousel system. Many such compartment baskets 43 installed in position constitute the food conveying mechanism for the current microwave and hot oil carousel oven system. The food products to be processed in the oven 10 are placed individually in the compartment basket 43. FIG. 6 shows one embodiment of the compartment basket 43. Other embodiments can be designed by one skilled in the art. The compartment basket 43 which is made of a dielectric material has bars 59 confining the individual food product 46 at the top as well as at the two sides of the basket. The bottom of the basket, however, is opened and the food product in the basket contacts the oven floor 63a in operation. The bars 59, the cylindrical inner sidewall of oven 10, the oven floor 63a and the outer surface of the carousel drive shaft 57 constitute the stationary as well as the moving confinement boundaries of the individual food product in the compartment basket 43. The food product is confined within these boundaries when it is cooked or heated in the compartment basket, which is driven by the carousel 8 and is rotating on the oven floor 63a.

During operations, the individual food product in the compartment basket 43 is initially out of the hot oil region, but is cooked or heated by microwave energy alone. It then gradually enters the hot oil region and being cooked or heated simultaneously by both the hot oil and the microwave energy. At the final stage, the food product is out of the hot oil region again and is continue to be cooked or heated by the microwave energy until it is removed from the oven. When each basket 43 reaches the position above the opening of the oven floor 63a at 45 (shown in both FIGS. 3 and 5), the individual food product in the basket will drop down to the food receptacle compartment 11 (Please see FIG. 3 for location of receptacle compartment 11) through the opening. If the carousel rotational direction 65 as shown by the arrow in FIG. 5 is chosen, the opening at 45 will be located as depicted, such that the individual food product will drop down to the receptacle compartment 11 prior to reaching the front center of oven 10. The food receptacle compartment 11 may include a Teflon slide (not shown) or the like beginning proximate boundary line 64. The shaded area 63 in FIG. 5 represents the portion of the oven floor 63a made of a dielectric material as described previously with the illustration in FIG. 3. It should be noted that if the food products to be processed are relatively small loose pieces such as French fries, such food products can be placed in another confinement as a group, such as in a meshed bag made of a dielectric material. This meshed bag is then placed in the compartment basket 43 for processing in oven 10.

Shown in FIGS. 4 and 5 is a front door 47 of oven 10. Air inlet holes 38 on door 47 shown in FIG. 4 are provided for the intake of the fresh airs into oven 10. When the operator opens the door 47, the microwave power as well as the power to drive the carousel system is automatically shut off. The operator can then place the food products to be cooked or to be heated into the food compartment basket 43. The operator also removes the cooked or heated food products from the food receptacle compartment 11 while the door 47 is opened. To resume the microwave as well as the carousel operations, door 47 must be closed and the system switch 69 shown in FIG. 1A must be in the “on” position. When the system switch 69 is in the “off” position, all system power is shut off. An optional delay switch can be provided for the exhaust system 40. This delay switch allows the exhaust system to continue running for a period of time after the system switch is turned off.

As described earlier, the hot oil enters oven 10 and the air exhausts from oven 10 through relatively small holes on the perforated walls of oven 10. The holes 51 on the oven floor 63a of oven 10 as well as the holes 68 on the cylindrical sidewall of oven 10, as depicted in FIGS. 4 and 5, are small enough to keep the microwave from leaking through the walls.

The top of the oven 10 can be separated from the bottom part of the oven at the joint line 62 shown in FIG. 4, by a simple removal of the binding means such as screws. When the top is removed, the shaft 56 and the main drive shaft 27 can be separated at their coupling point. This removal of the oven top is designed to be relatively easy for the purpose of a periodical cleaning of the carousel mechanism inside the oven 10.

The present cooking or heating system that is discussed so far, using the microwave and hot oil, can be replaced by a system using the microwave and hot gas, typically hot air. The system can also be replaced by a system using the microwave and combined hot oil and hot gas. The system using the microwave and hot gas is illustrated in FIG. 1C. It is shown that the previous oil heater system is replaced by a hot gas system 82. Similar to the system using hot oil, the hot gas is heated by the heater system 13 and enters the oven 10 through the perforated wall 36. Using a blower 80, the hot air is sucked out of oven 10 and blown through the filter system 14 before entering the heater region. It is shown by the arrows, the air-circulation loop is formed with a natural heat convection above the heater system 13 as well as the forced convection created by the blower 80. In operation, the blower (not shown) in the exhaust system 40 is turned off. The blower in the exhaust system 40 can be turned on periodically to blow out the hot gas that has been circulated in the system.

The other system using the microwave and combined hot oil and hot gas is illustrated in FIG. 1D. This system includes the previously discussed oil heater system 12 as well as a hot gas generator 85 as depicted in FIG. 1D. The hot gas generator 85 has a gas inlet 87, through which the unheated gas enters the hot gas generator. The hot gas generated is then fed into oven 10 through outlet 86 of the hot gas generator and the opening at 45 (shown in both FIGS. 3 and 5) between the oven floor and the receptacle compartment 11. During operation, the blower (not shown) in the exhaust system 40 is turned on to blow out the hot gas as well as the unwanted moisture and possibly bubbles from frying as mentioned earlier.

Some or all of the magnetrons 15 could also comprise, by way of example but without limitation, other electromagnetic wave generator(s) or light bulbs, such as, for example, a source for a wave in the infrared range of the electromagnetic spectrum.

What is claimed is:

1. An apparatus for cooking/heating a food product, comprising:
an oven;
a carousel for the food product mounted in the oven and having a main drive connected to the carousel;
an oven cleaning system mounted in the oven;
a convection medium within the oven; and
a source for a wave in an electromagnetic spectrum mounted in the oven.

2. The apparatus according to claim 1, further including an enclosure wherein the oven and the source for a wave in an electromagnetic spectrum are mounted in the enclosure.

3. The apparatus according to claim 1 wherein the oven is a cylindrical oven.

4. The apparatus according to claim 1 wherein said oven cleaning system comprises at least one sweeper mounted within the carousel and having a sweeper strip at the outer end which touches an inner surface of the oven.

5. The apparatus according to claim 4 wherein said sweeper includes a sweeper frame connected to the carousel and housing said sweeper strip, wherein said sweeper frame has a dimension excluding contact and proximate the inner surface of the oven.

6. The apparatus according to claim 1 wherein the convection medium comprises at least one convection medium selected from the group consisting of a volume of hot oil, and a volume of hot gas.

7. The apparatus according to claim 1 wherein the source for the wave in the electromagnetic spectrum comprises at least one source selected from the group consisting of a microwave source, and an infrared light source.

8. The apparatus according to claim 1 wherein the convection medium comprises a volume of hot oil and a volume of hot gas.

9. The apparatus according to claim 1 wherein the source for the wave in the electromagnetic spectrum comprises a microwave source and an infrared light source.

10. The apparatus according to claim 1 further including a plurality of compartment baskets connected to the carousel.

11. The apparatus according to claim 1, further including a food receptacle compartment connected to the oven.

12. The apparatus according to claim 2, further including an oil heater system connected to the enclosure.

13. The apparatus according to claim 2, further including an exhaust system connected to the enclosure.

14. The apparatus according to claim 2, further including a convection medium circulation system connected to the enclosure.

15. The apparatus according to claim 1, wherein the oven is tilted at an angle with respect to a horizontal plane.

16. A method for heating a food product, comprising the steps of:
heating the food product with at least one convection medium selected from the group consisting of a volume of hot oil, and a volume of hot gas; and
heating the food product with a wave in an electromagnetic spectrum having a frequency outside the range of a microwave frequency.

17. The method according to claim 16, further including the step of heating the food product with an electromagnetic wave within the microwave frequency.

18. The method according to claim 17, further including the step of cleaning an oven within which the food product is heated performed simultaneously with said step of heating the food product.

19. A method for heating a food product, comprising the steps of:
heating the food product with a volume of hot gas; and
heating the food product with a wave in an electromagnetic spectrum having a frequency within the range of a microwave frequency.

20. The method according to claim 19, further including the step heating the food product with a volume of hot oil.

21. The method according to claim 20, further including the step of cleaning an oven within which the food product is heated performed simultaneously with said step of heating the food product.
